(19) United States
(12) Patent Application Publication
(10) Pub. No.: US 2008/0177907 A1
(43) Pub. Date: Jul. 24, 2008

(54) METHOD AND SYSTEM OF A PERIPHERAL PORT OF A SERVER SYSTEM

(76) Inventors: Paul Boerger, Loveland, CO (US); Fred C. Thomas, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/625,915

(22) Filed: Jan. 23, 2007

(51) Int. Cl. G06F 3/00

(52) U.S. Cl. 710/15

(57) ABSTRACT

A method and system of a peripheral port of a server system. At least some of the illustrative embodiments are a server system comprising a processor, a non-volatile storage device coupled to the processor, a peripheral port coupled to the processor, and an indicator coupled to the processor (and the indicator associated with the peripheral port). The server system does not support a directly coupled display device, the processor determines whether a device coupled to the peripheral port is supported by the server system, and the processor drives the indicator to indicate whether the device is supported.

### BACKGROUND

A characteristic of servers that distinguishes servers from other computer systems is the lack of directly coupled input/output devices, such as display and keyboard. As the use of servers in home environments expands additional functionality is demanded by consumers, but the additional functionality is difficult to provide in a user friendly manner given the lack of a directly coupled display and keyboard. An example of functionality that is difficult to provide in a user-friendly manner is peripheral ports. Many devices may be coupled physically to peripheral ports of a server in the home, but not all devices may be supported. Given the absence of a directly coupled display, it is difficult to convey to the user of the server in the home whether a particular device coupled to a peripheral port is supported and/or operational.

### BRIEF DESCRIPTION OF THE DRAWINGS

For a detailed description of exemplary embodiments, reference will now be made to the accompanying drawings in which:

FIG. 1 shows a home networking system in accordance with at least some embodiments;

FIG. 2 shows a network attached storage device in accordance with at least some embodiments; and

FIG. 3 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical connection, or through a wireless electrical connection.

### DETAILED DESCRIPTION

The following discussion is directed to various embodiments. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

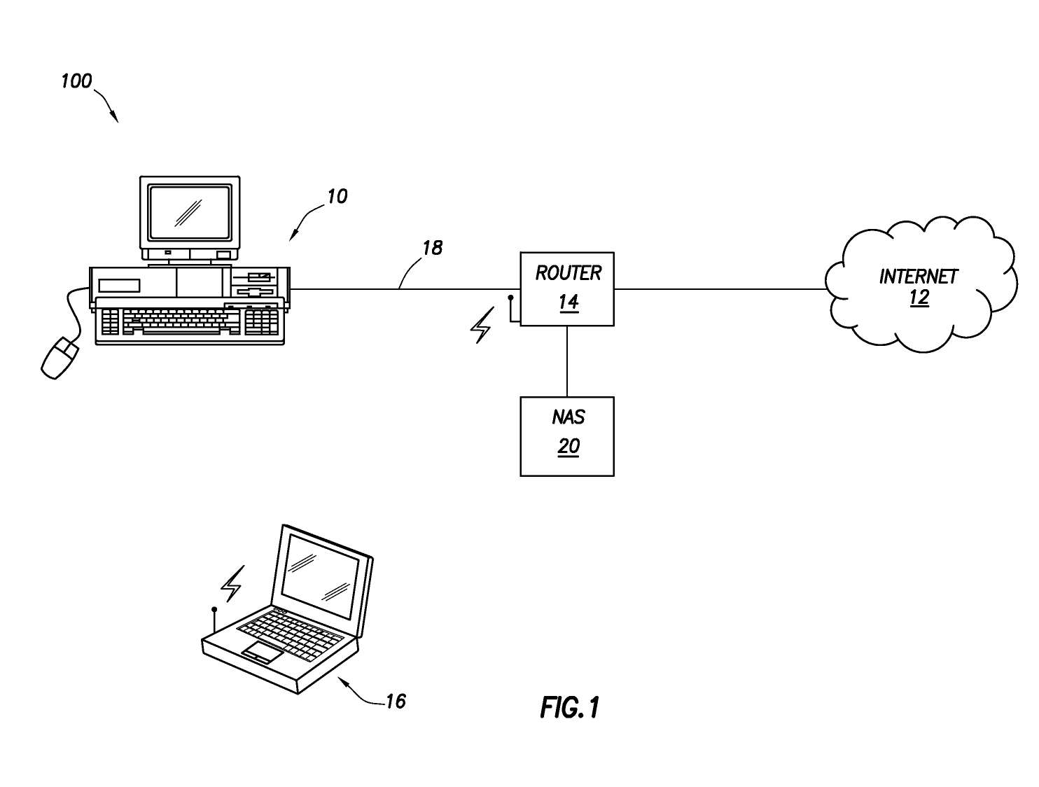

FIG. 1 illustrates a home networking system 100 in accordance with at least some embodiments. In particular, the home networking system 100 comprises an illustrative desktop computer system 10 coupled to the Internet 12 by way of a router 14. The home networking system 100 also comprises a second computer system, in this case a notebook computer 16 coupled to the Internet 12 by way of the router 14. In the embodiments illustrated in FIG. 1, desktop computer 10 couples to the router by way of a hardwired connection 18 (e.g., an Ethernet connection) and illustrative notebook computer 16 couples to the router 14 wirelessly (e.g., IEEE 802.11, Bluetooth). However, computer systems may couple to the router in a hardwired fashion or wirelessly without regard to their portability. Further, while the system 100 of FIG. 1 shows only one desktop computer 10 and one notebook computer 16, any number of computers may be coupled to the router using any networking functionality.

The home networking system 100 of FIG. 1 also comprises a network attached storage (NAS) device 20 coupled to the router 14. In accordance with at least some embodiments, the network attached storage device 20 is a storage device and/or server available to any computer system of the home networking system 100 (e.g., desktop computer 10 or notebook computer 16). The network attached storage device 20 may be, for example, the central repository for data generated by computers of the home networking system 100. In the embodiments illustrated in FIG. 1, the storage implemented by network attached storage device 20 is accessible to other computers of the home networking system by way of any suitable currently available networking communication protocol (e.g., Internet Protocol (IP), Transmission Control Protocol/Internet Protocol (TCP/IP)), or any after-developed networking protocol.

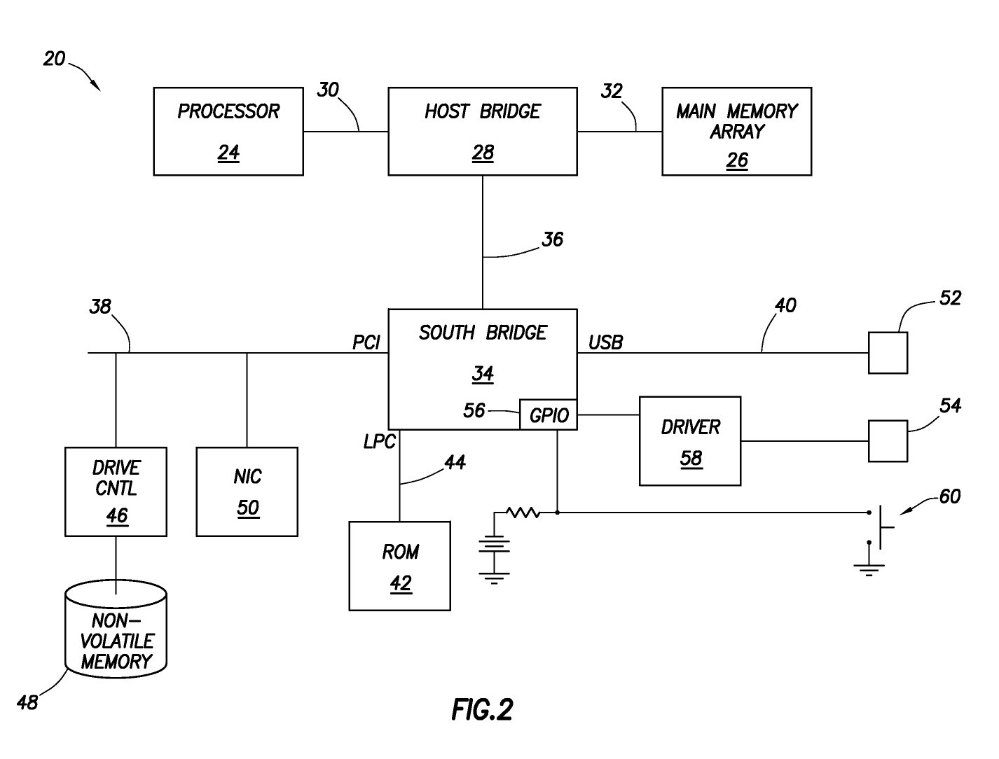

FIG. 2 illustrates in greater detail the network attached storage device 20. In particular, network attached storage device 20 comprises a processor 24 coupled to a main memory array 26, and various other components, through integrated host bridge 28 (sometimes referred to as a “north bridge” because of its location in computer system drawings). The processor 24 couples to the host bridge 28 by way of a host bus 30, or the host bridge 28 may be integrated into the processor 24. The processor 24 may be one of many available processors, and thus the network attached storage device 20 may implement bus configurations or bus-bridges in addition to, or in place of, those shown in FIG. 2.

Main memory array 26 couples to the host bridge 28 through a memory bus 32. Those host bridge 28 comprises a memory control unit that controls transactions to the main memory 26 by asserting control signals for memory accesses. The main memory array 26 functions as the working memory for the processor 10 and comprises a memory device or array of memory devices in which programs, instructions and data are stored. The main memory array 26 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM), etc.

Still referring to FIG. 2, the network attached storage device also comprises a second bridge 34 that bridges the primary expansion bus 36 to various secondary expansion buses, such as the peripheral component interconnect (PCI) bus 38 and the universal serial bus (USB) 40. The second bridge 34 is sometimes referred to as the “south bridge” because of its location in computer system drawings. Read only memory (ROM) 42 couples to the south bridge 34, such as by a low pin count (LPC) bus 44. The ROM 42 contains software programs executable by the processor 10 to enable the system 20 to perform as a network attached storage device.

Network attached storage device 20 further comprises a hard drive controller 46 coupled to the south bridge 34 by way of the illustrative PCI bus 38. In alternative embodiments, the hard drive controller may couple to the primary expansion bus 36, or any other currently available or after-developed expansion bus. The drive controller 46 controls the non-volatile memory 48 of the hard drive. In some embodiments, the network attached storage device 20 implements a single hard drive where computer systems of the home network can store and retrieve data and programs. In alternative embodiments, the network attached storage device implements a redundant array of independent (or inexpensive) drive (RAID) system where the data and instructions written to the network attached storage 20 are duplicated across multiple hard drives to implement fault tolerance.

Also coupled to the illustrative PCI bus 38 is a network interface card (NIC) 50. In alternative embodiments, the functionality of the NIC 50 is integrated onto the motherboard along with the bridges 28 and 34. The NIC 50 enables the network attached storage device 20 to communication with computer systems on the home networking system 100 (through the router 14, both of FIG. 1) such that the network attached storage device 20 may act as the central repository for data and programs of the home network system.

Because the network attached storage device 20 is designed to act as a server for the home networking system 100, and possibly to reduce cost, in accordance with at least some embodiments the network attached storage device 20 does not support direct coupling of a display device and/or keyboard. Thus, in some embodiments the network attached storage device 20 does not implement a graphics controller that would couple to a display, and also does not implement an input/output (I/O) controller that would couple to I/O devices such as a keyboard and mouse. To the extent administration is performed on the network storage device 20, the administration may be done remotely using computer systems (e.g., desktop computer 10 or notebook computer 16) in the home networking system 100.

In accordance with at least some embodiments, the network attached storage device 20 provides the user one or more peripheral ports to which to couple peripheral devices (e.g., flash memory devices, digital cameras, scanners, printers). In the illustration of FIG. 2, the peripheral port is shown as a USB port 52; however, implementing a USB port 52 is merely illustrative, and any suitable peripheral bus protocol may be used (e.g., IEEE 1394 “fire wire,” IEEE RS232, external serial ATA (ESATA)).

It is possible, however, that a user may couple a peripheral device to the peripheral port 52 which is not supported by the network attached storage device 20. For example, the user may couple a printer to the network attached storage device 20 for which no driver program is present. Given the lack of a display device and/or keyboard, it is difficult to quickly and efficiently inform the user of the operability or lack of operability of a device attached to the peripheral port. In order to address concerns of informing the user of operability of attached peripheral devices, and in accordance with at least some embodiments, the network attached storage device 20 implements an indicator 54 that is associated with and located proximate to the peripheral port 52.

In accordance with at least some embodiments, the indicator 54 gives the network attached storage device 20 user an indication of the operability (or lack of operability) of a peripheral device coupled to the peripheral port 52. In some embodiments, the indicator is a visual indicator, such as a light emitting diode, incandescent bulb, fluorescent bulb, laser diode or laser device. In other embodiments, the indicator 54 is an audible indicator, such as an electric buzzer, or tone generator coupled to a speaker. In yet still other embodiments, the indicator is a combination of multiple visual indicators, or a combination of visual indicators and an audible indicator.

Operating the indicator 54 could take many forms. In some embodiments, one or more outputs of a set of general purpose I/O (GPIO) 56 of the south bridge 34 may couple to a driver circuit 58, which in turn drives the indicator 54. In some embodiments, the driver circuit 58 couples power to the indicator 54 responsive to the assertion of a GPIO 56. In the case of a tone generator, the driver circuit 58 may generate signals of appropriate frequency, or a series of frequencies, to be applied to the speaker. Utilizing GPIO 56 of the south bridge 34 is merely illustrative. Any available digital output signal within the network attached storage device 20 may be used to communicate to the driver circuit 58. Alternatively, the processor 24 may communicate to the driver circuit 58 by other communication systems, such as by coupling the driver circuit 50 to a secondary expansion bus, such as the PCI bus 38.

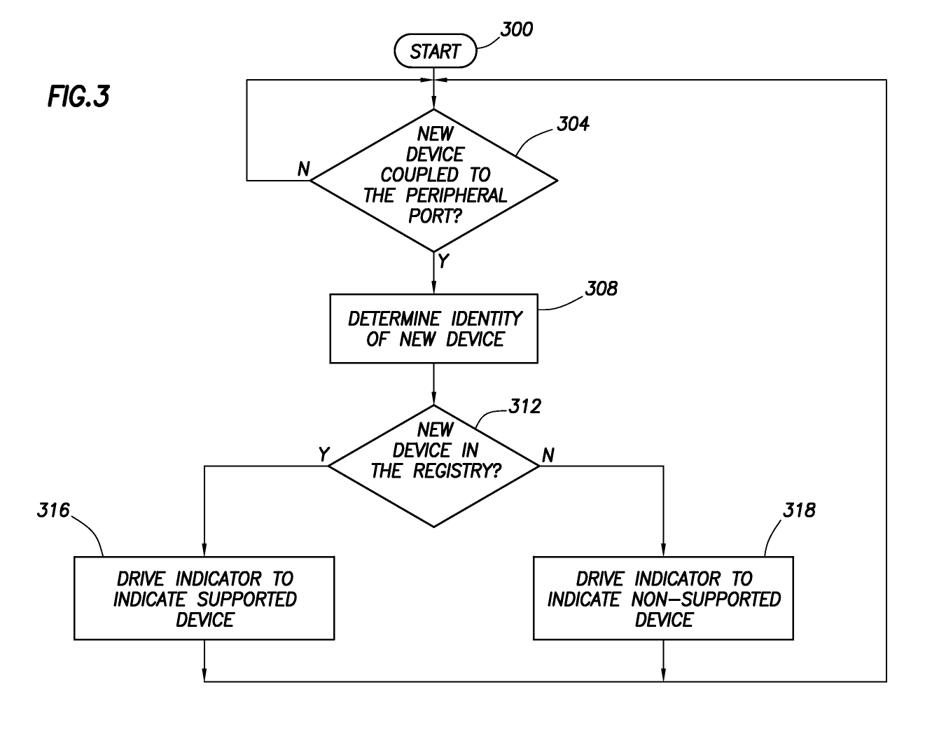

FIG. 3 illustrates a method in accordance with at least some embodiments. In particular, the method starts (block 300) and proceeds to determining whether a new device has been coupled to a peripheral port 52 of the network attached storage device (block 304). If no new device has been coupled to a peripheral port, the method loops. If a new device has been attached, the identity of the new device is determined (block 308), such as by communicating with the new device through the peripheral port. Once identified, a determination is made as to whether the device has an entry in the registry of the network attached storage device 20 (block 312). The registry lists all devices for which drivers are present and/or which are otherwise operational with the network attached storage device 20. If the newly attached device has a registry entry (again block 312), the illustrative method moves to driving the indicator 54 to indicate support for and/or operability of the attached device with the network attached storage device (block 316). Driving to indicate operability may take many forms. In some embodiments a light of a particular color is illuminated (e.g., green) to indicate operability. In embodiments where only a single light source is available, the light may be pulsed at a particular frequency to indicate a lack of operability, and driven solid to indicate operability, or vice versa. In addition to or in place of driving of the lights, a tone or series of tones may be generated to indicate operability.

Returning to the illustrative determination of whether there is a register entry for the newly coupled device (block 312), if there is not a registry entry (or the device is otherwise not supported), the method proceeds to driving the indicator 54 to indicate non-support and/or lack of operability of the newly attached device with the network attached storage device (block 318). Driving to indicate a non-supported device likewise may take many forms. In some embodiments a light of a particular color is illuminated (e.g., red) to indicate the non-support. In embodiments where only a single light source is available, the light may be pulsed at a particular frequency to indicate operability, and driven solid to indicate lack of operability, or vice versa. In addition to or in place of driving of the lights, a tone or series of tones may be generated to indicate non-support for the newly attached device.

The various embodiments discussed to this point have been directed to determining whether a peripheral device attached to a peripheral port 54 is supported by the network attached storage device 20, and informing the user of the determination in some form. Further embodiments also enhance the user's experience when utilizing devices coupled to the peripheral ports. In some of these further embodiments, the network attached storage device 20 compensates for slow access times of peripheral devices attached to the peripheral port, and yet still further embodiments move functionality of the attached peripheral device to the network attached storage device. Each of these is discussed in turn.

Many of the peripheral devices that may couple to the peripheral port 54 have data and programs stored on memory of the peripheral device that, ultimately, the user will want to copy to the hard drive(s) of the network attached storage device 20 and/or to computer systems of the home networking system 100. However, data transfer rates from the peripheral devices (e.g., a flash memory device, a digital still camera, a digital video camera) may be relatively slow, and in the case of digital video may be too slow to stream directly from the peripheral device. In accordance with at least some embodiments, the network attached storage device assesses the communication speed of the attached peripheral storage device, and in cases where the communication speed is low compared to the type or size of data stored on the peripheral device, the network attached storage device 20 reads the data from the memory of the peripheral device and caches or mirrors the data on the hard drive of the network attached storage device 20. Thus, so long as the peripheral device is attached to the peripheral port 52, the network attached storage device 20 maintains a cached copy of the data. When the user requests the data, the data is provided from the cached copy from the hard drive(s) of the network attached storage device 20. Thus, the data may be provided from the cached copy on the hard drive of the network attached storage device 20 faster than if the data is copied from the peripheral device across the peripheral port 52 each time the data is requested.

Returning to FIG. 2 and turning now to moving functionality of the attached peripheral device to the network attached storage device. In at least some embodiments, in addition to the indicator 54 located proximate to the peripheral port 52, a switch or button 60 is likewise located proximate to the peripheral port 52. In some embodiments, the button 60 couples to the GPIO 56, such as through a pull up resistor configuration. Actuating the button 60 when a peripheral device is coupled to the peripheral port 52 instigates an action with respect to the peripheral device. For example, if the peripheral device is a flash memory, actuation of the button 60 may initiate a complete memory copy from the flash memory to memory of the network attached storage device 20. As yet another example, if the peripheral device is a scanner, actuation of the button 60 may initiate a scan by the scanner, such as by having the network attached storage device 20 communicate through the peripheral port 52 to instruct the scanner to begin the scan function. The flash memory and scanner peripheral devices are merely illustrative. Many different actions of the peripheral device may be triggered based on actuation of the button 60.

What is claimed is:

1. A server system comprising:
a processor;
a non-volatile storage device coupled to the processor;
a peripheral port coupled to the processor; and
an indicator coupled to the processor, and the indicator associated with the peripheral port;
wherein the server system does not support a directly coupled display device; and
wherein the processor determines whether a device coupled to the peripheral port is supported by the server system, and wherein the processor drives the indicator to indicate whether the device is supported.

2. The server system as defined in claim 1 wherein the peripheral port operates under one or more selected from the group consisting of: a universal serial bus (USB) protocol; an Institute for Electrical and Electronics Engineers (IEEE) 1394 protocol; an IEEE RS232 protocol; and an external serial ATA (ESATA) protocol.

3. The server system as defined in claim 1 wherein the indicator is a light producing device located proximate to the peripheral port.

4. The server system as defined in claim 3 wherein the light producing device is one or more selected from the group consisting of: a light emitting diode; an incandescent bulb; a fluorescent bulb; and a laser.

5. The server system as defined in claim 1 wherein the indicator is an audible indicator.

6. The server system as defined in claim 1 wherein the indicator comprises a light producing device and an audible device.

7. The server system as defined in claim 1 wherein the processor caches data from a memory device coupled to the peripheral port to the non-volatile memory, and supplies the data of the memory device to requesting devices from the cache.

8. The server system as defined in claim 1 further comprising:
a button electrically coupled to the processor and associated with the peripheral port;
wherein the server system does not support a directly coupled keyboard; and
wherein the processor, responsive to the button, triggers a peripheral device coupled to the peripheral port to perform an action.

9. The server system as defined in claim 8 wherein the peripheral device is a scanner, and wherein the processor, responsive to the button, initiates a document scan.

10. A method comprising:
operating a server system that does not support a directly coupled display device;
determining an identity of a peripheral device coupled to the server system by way of a peripheral port;
searching a registry to determine if the peripheral device is supported by the server system; and
driving an indicator proximate to the peripheral port if the peripheral device is supported.

11. The method as defined in claim 10 wherein determining further comprises communicating with the peripheral device over the peripheral port operating under one or more selected from the group consisting of: a universal serial bus (USB) protocol; an Institute for Electrical and Electronics Engineers (IEEE) 1394 protocol; an IEEE RS232 protocol; and an external serial ATA (ESATA) protocol.

12. The method as defined in claim 10 wherein driving further comprises driving one or more selected from the group consisting of: a light emitting diode; an incandescent bulb; a fluorescent bulb; a laser; and an audible device.

13. The method as defined in claim 10 further comprising;
caching data from the peripheral device being a memory device to memory of the server system; and
supplying the data of the memory device to requesting devices from the cache.

14. A server system comprising:
a processor;
a non-volatile storage device coupled to the processor;
a peripheral port coupled to the processor; and
a button coupled to the processor, and the button associated with the peripheral port;
wherein the server system does not support a directly coupled keyboard; and
wherein the processor, responsive to the button, triggers a peripheral device coupled to the peripheral port to perform an action.

15. The server system as defined in claim 14 wherein the peripheral device is a scanner, and wherein the processor, responsive to the button, initiates a document scan.

16. The server system as defined in claim 14 wherein further comprising:
an indicator coupled to the processor, and the indicator associated with the peripheral port;
wherein the server system does not support a directly coupled display device; and
wherein the processor determines whether the peripheral device coupled to the peripheral port is supported by the server system, and wherein the processor drives the indicator to indicate whether the device is supported.

17. The server system as defined in claim 14 wherein the indicator is a light producing device located proximate to the peripheral port.

18. The server system as defined in claim 17 wherein the light producing device is one or more selected from the group consisting of: a light emitting diode; an incandescent bulb; a fluorescent bulb; or a laser.

19. The server system as defined in claim 14 wherein the indicator is an audible indicator.

20. The server system as defined in claim 14 wherein the peripheral port operates under one or more selected from the group consisting of: a universal serial bus (USB) protocol; an Institute for Electrical and Electronics Engineers (IEEE) 1394 protocol; an IEEE RS232 protocol; and an external serial ATA (ESATA) protocol.
